(19) United States
(12) Patent Application Publication
(10) Pub. No.: US 2015/0272192 A1
(43) Pub. Date: Oct. 1, 2015

(54) RAMEN NOODLE MEAT PRODUCT

(71) Applicant: Cargill Incoprorated, Wayzata, MN (US)

(72) Inventors: Janet Bourbon, Wichita, KS (US); Mark David Meckstroth, Wichita, KS (US); Chad Allen Schafer, Wichita, KS (US); Brock Aaron Zentz, Andover, KS (US)

(73) Assignee: Cargill, Incorporated, Wayzata, MN (US)

(21) Appl. No.: 14/672,999

(22) Filed: Mar. 30, 2015

Related U.S. Application Data
(60) Provisional application No. 61/972,612, filed on Mar. 31, 2014.

(51) Int. Cl. A23L 1/317

(52) U.S. Cl. CPC A23L 1/3177; A23V 2002/00

(57) ABSTRACT

A patty having improved flavor and texture and a composition for making such patty is disclosed. The invention is particularly directed to a patty having a protein material, a sufficient amount of rumen noodles and a binder material. In some instances the patty may also include seasoning ingredients or other particulates such as grains, vegetables, cheese or nuts.

### CROSS REFERENCE TO RELATED APPLICATION

This application claims the benefit of U.S. Patent Application, Ser. No. 61/972,612, filed Mar. 31, 2014, entitled RAMEN NOODLE MEAT PRODUCT, which is hereby incorporated by reference in its entirety.

### TECHNICAL FIELD

The present disclosure relates generally to a patty having improved flavor and texture and a composition for making such patty.

Aspects of the disclosure are particularly directed to a patty comprising ramen noodles.

### BACKGROUND

The changing tastes of consumers have vexed food marketers for years. Changes in ethnic composition, attitudes of different age groups and health issues have led food marketers to invest heavily in consumer insights and research to determine what consumers want. The one thing that has not changed over the years, however, is that taste is the main reason people buy food. Survey after survey bears this out proving that taste is the number one reason for purchasing specific foods. And the food industry has responded to this by introducing familiar foods like hamburgers that incorporate new flavors such as chipotle pepper, smoked paprika or mole rub for a spicy hot taste or tapping into Asian flavor profiles by adding Sriracha hot sauce, hoisin sauce or wasabi mayonnaise. What these options have failed to address, however, is that texture is as vital to the experience of food as flavor. When food is criticized as “lacking texture,” it is not that the food has no texture, it is that the food lacks textural contrast. For example, in a sandwich, a chewy, artisan bread would play off the texture of the crisp veggies and the juiciness of the meats and the creaminess of the cheese. In a sandwich where the bread is squishy, the meat is squishy, the cheese is floppy, and the veggies sort of even lack crunch, the sandwich lacks the interplay of various textures. It becomes one note. The present invention solves this problem by delivering a patty composition rich in both flavor and texture, which can be formulated in a number of ways. The invention also provides patties made with the composition of the present invention.

### SUMMARY OF THE INVENTION

The present invention is directed to a food composition having a protein material, a ramen noodle and a binder material. In one aspect, the food composition includes from about 25 percent to 60 percent by weight of the total food composition of a protein material from about 20 percent to 55 percent by weight of the total food composition of a ramen noodle from about 4 percent to 20 percent by weight of the total food composition of a binder material. In another aspect of the present invention, the food composition further includes one or more of a seasoning ingredient and water.

In an aspect, the protein material includes one or more of beef, pork, turkey, chicken, duck, goose, fish, or shellfish. In a particular aspect the protein material is beef.

In another aspect, the binder material includes one or more of egg, soy, starch, salt, oat fiber, wheat glucose, methyl cellulose, modified wheat gluten, oil and bread crumbs. In a certain aspect the binder material comprises egg.

The food composition of claim 2 wherein the seasoning ingredient comprises one or more of asafoetida, achiote paste and powder, allspice, annatto seeds, bay leaf, caraway seed, cardamom, cayenne pepper, chia seeds, cinnamon, cloves, coriander, cumin, fennel seed, fenugreek, garlic powder, gochugaru, grains of paradise, loomi, mace, mahlab, mustard, nutmeg, black pepper, white pepper, nutritional yeast, oregano, paprika, rosemary, saffron, sage, salt, smoked paprika, star anise, sumac, turmeric, thyme, cinnamon, basil, chervil, dill, lemon thyme, marjoram, mint, summer savory, shiso, tarragon, baharat, bouquet garni, chili powder, curry powder, dukkah, herbes de provence, ras el hanout, chipotle seasoning, mojo seasoning blend, or za'atar seasoning blend.

The food composition of claim 7 wherein the seasoning ingredient comprises mojo seasoning blend.

In a specific aspect of the present invention is a food composition having from about 25 percent to 60 percent by weight of the total food composition beef, from about 20 percent to 55 percent by weight of the total food composition of a ramen noodle and from about 4 percent to 20 percent by weight of the total food composition of egg. In certain aspects of the present invention, the food composition further includes one or more of a seasoning or water.

The present invention is also directed to a patty that includes a food composition having a protein material, a ramen noodle and a binder material. In one aspect, the food composition includes from about 25 percent to 60 percent by weight of the total food composition of a protein material from about 20 percent to 55 percent by weight of the total food composition of a ramen noodle from about 4 percent to 20 percent by weight of the total food composition of a binder material. In another aspect of the present invention, the food composition further includes one or more of a seasoning ingredient and water. The patty may be in various shapes. In one aspect, the shape of the patty is a circle, triangle or rectangular stick. In a further aspect, the thickness of the patties is from about 0.0635 cm to 1.27 cm. In yet another aspect the thickness of the patties is 0.952 cm.

### BRIEF DESCRIPTION OF THE DRAWINGS

FIG. 1 is a picture illustrating a raw hamburger patty manufactured with the composition according to the present invention.

FIG. 2 is a picture illustrating a cooked hamburger patty manufactured with the composition according to the present invention.

### DETAILED DESCRIPTION

### Overview

Specific details of several embodiments of the disclosure are described below. As used herein, the term “patty” generally refers to a flattened, usually round, although other forms such as sticks are possible, serving of ground meat or meat alternatives. The meat is compacted and shaped, cooked, and served. Patties can be eaten with a knife and a fork in dishes like Salisbury Steak, but are typically served in a sort of sandwich called a “burger”, or a hamburger if the patty is made from ground beef. Similar-shaped “meat” cakes not made from ground beef may also be called “burger” such as turkey burgers, pork burgers, chicken burgers, fish burgers and veggie burgers which are made without animal products.

Several other embodiments of the present invention system may have different configurations, components, or procedures than those described in this section. For example, combinations of meat substitute protein sources and vegetables can also be used in producing patties of the present invention. Additionally, the composition of the present invention may be used to make food products other than patties where ground meat or meat substitute is a key ingredient, such as for example, meat loaf and meat balls. A person of ordinary skill in the art, therefore, will understand that the invention may have other embodiments with additional elements, or the invention may have other embodiments without several of the elements shown and described below.

In one aspect of the present invention is a composition that comprises a protein material, ramen noodles and one or more binder materials. The composition may further comprise one or more of water and seasoning ingredients.

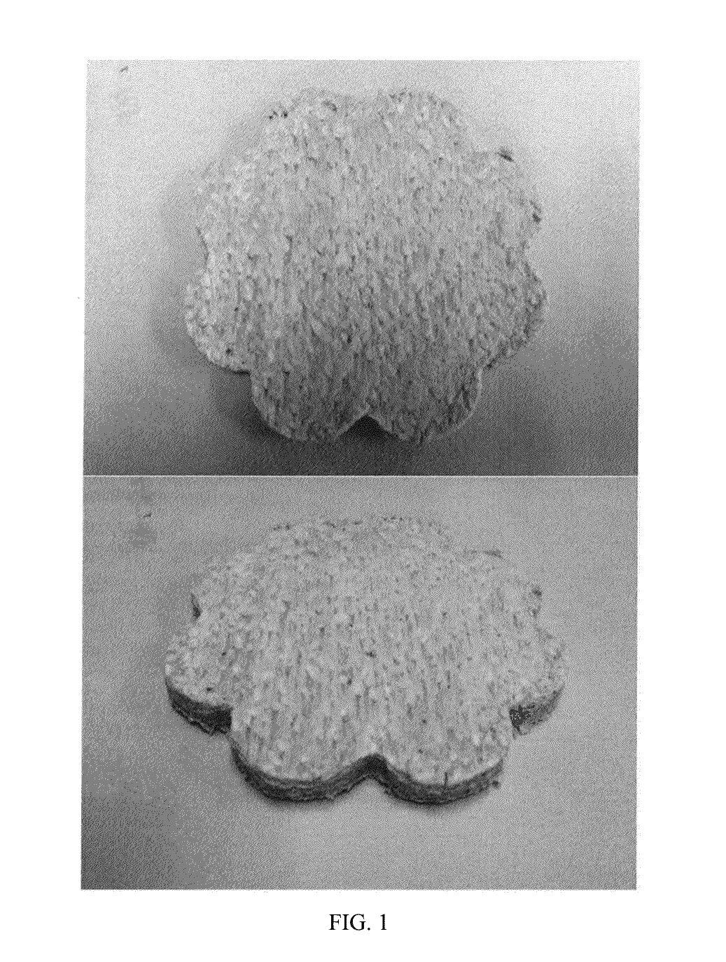

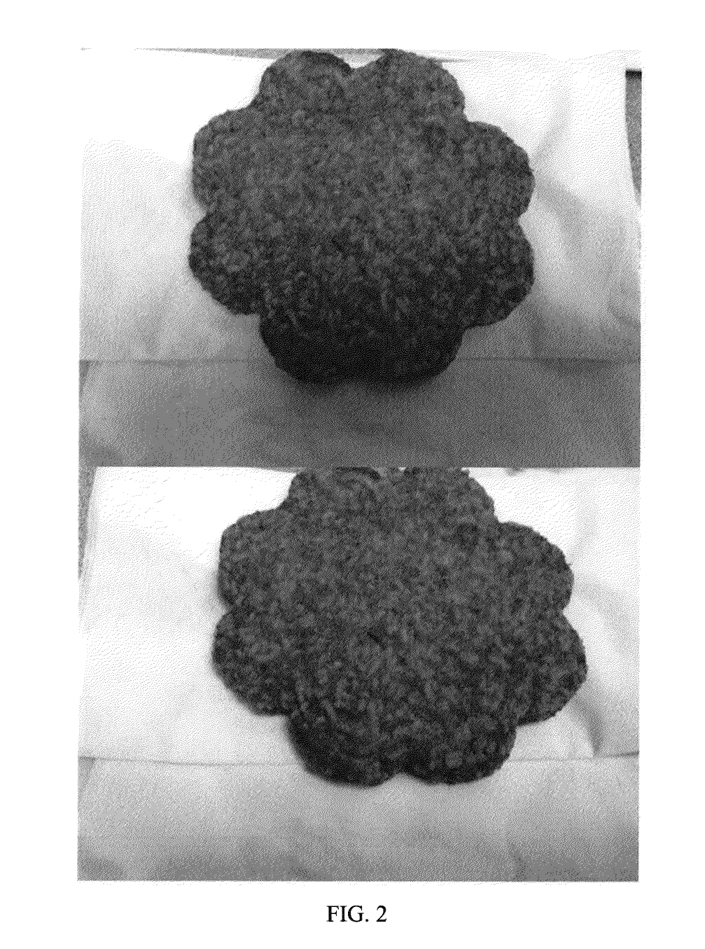

In a second aspect of the present invention is a patty comprising the composition. The patties may be in a variety of shapes, sizes and weights depending on the application and preference of the consumer. In a particular aspect, as illustrated in FIGS. 1 and 2, the shape of the patties is round. In another aspect, the shape of the patties is a generally rectangular stick or triangular wedge. In still another aspect the thickness of the patties is from about 0.0635 cm to 1.27 cm. In yet another aspect the thickness of the patties is 0.952 cm.

The inclusion level of the various ingredients in the composition of the present invention is an important aspect. If the protein material, ramen noodles and binder materials are not used at the appropriate levels, it may be difficult to form a patty that can resist breaking or crumbling. Alternatively, the patty may have insufficient texture to deliver the taste consumers are looking for if insufficient levels of ramen noodles are used. Thus, although the individual components of the composition may be present in a variety of amounts, in one aspect of the present invention the protein material comprises from about 25 percent to 60 percent by weight of the total formula, the ramen noodle comprises from about 20 percent to 55 percent by weight of the total formula, the binder material comprises from about 4 percent to 20 percent by weight of the total formula. In a further aspect, the seasoning ingredients comprise from about 0.5 percent to about 4.5 percent by weight of the total formula. In a particular embodiment the composition was made by combining 40 percent by weight ground beef, 40 percent by weight dried ramen noodles, 5 percent by weight dried egg powder as a binder material, 3 percent by weight Cuban Mojo seasoning blend and 12 percent by weight water.

The protein material of the present invention may comprise any protein source used typically used in a patty. In one aspect of the present invention, protein material may refer to any type or cut of meat after slaughter and prior to cooking. For example, protein materials may include, but are not limited to, fresh, chilled, or frozen meat cuts. In a particular aspect of the present invention, the protein materials are ground meats. Suitable protein materials may be obtained from bovine, porcine, equine, caprine, ovine, avian animals, fish, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. In an aspect of the present invention, the protein material includes one or more of beef, pork, turkey, chicken, duck, goose, fish, or shellfish. In another aspect of the present invention, the protein material may be chosen from one or more non-animal protein products such as vegetables (e.g. corn), textured vegetable protein (e.g. soy), legumes (e.g. beans), tofu, nuts, mushrooms, or grains or seeds (eg. wheat, flax, rice). In yet another aspect of the present invention, the protein material may comprise animal and non-animal protein products. In a particular aspect of the present invention, the protein material is ground beef.

The ramen noodles of the present invention, are dried or precooked, such as by frying, noodles similar to those readily available in retail food markets. The main ingredients of the noodles are wheat flour, palm oil, and salt. Although the noodles are usually eaten after being cooked or soaked in boiling water, in the present invention the ramen noodles are maintained in their original, dehydrated form.

The binder material of the present invention may comprise any food safe binder material. In an aspect of the present invention, the binder material comprises one or more of egg, soy, starch, salt, oat fiber, wheat glucose, methyl cellulose, modified wheat gluten, oil and bread crumbs. In one aspect of the present invention, the composition comprises a single binder material. In another aspect of the present invention, the composition comprises two or more binder materials. In a particular aspect of the present invention, the composition comprises dried egg. In another aspect of the present invention, the composition comprises liquid egg. In one aspect of the present invention, egg also enhances delivery of the seasoning ingredients.

A wide variety of seasoning ingredients may be included in the composition of the present invention and one of ordinary skill in the art would be able to identify the appropriate seasoning ingredients for the patty. In a particular aspect of the present invention, the seasoning ingredient comprises one or more of asafoetida, achiote paste and powder, allspice, annatto seeds, bay leaf, caraway seed, cardamom, cayenne pepper, chia seeds, cinnamon, cloves, coriander, cumin, fennel seed, fenugreek, garlic powder, gochugaru, grains of paradise, loomi, mace, mahlab, mustard, nutmeg, black pepper, white pepper, nutritional yeast, oregano, paprika, rosemary, saffron, sage, salt, smoked paprika, star anise, sumac, turmeric, thyme, cinnamon, basil, chervil, dill, lemon thyme, marjoram, mint, summer savory, shiso, tarragon, baharat, bouquet garni, chili powder, curry powder, dukkah, herbes de provence, ras el hanout, chipotle seasoning, mojo seasoning blend, or za'atar seasoning blend. The present invention may also be used together with a seasoned dipping sauce or condiment.

It is also contemplated that one or more other ingredients such as cheese, vegetables, nuts, seeds, condiments, grains such as malt, wheat, barley, rice and other specialty grains such as quinoa and flax may be added to the composition of the present invention. Without intending to limit the present invention, in one embodiment the composition of the present invention comprises one or more of green peppers, red peppers, peas, jalapeno peppers, habemaro peppers, onions, mushrooms, brocolli, carrots, cauliflower, asparagus, green beans, lettuce, kale tomatoes, corn, potatoes, beets, squash, edamame, or zucchini.

The manufacturing method of the composition of the present invention comprises mixing a protein material using commercially available equipment with ramen noodles for a time sufficient to evenly distribute the ramen noodles throughout the protein material to form a base mixture and subsequently mixing in a binding material until the binding material is evenly distributed throughout the base mixture to form one aspect of the composition of the present invention. In a further aspect of the present invention, one or more seasoning ingredients, water or a combination thereof are mixed with the base mixture either simultaneously with the binding material or separately from the binding material to form another aspect of the composition of the present invention. In one aspect of the present invention, the composition may be transferred to a forming machine and patties are formed to desired dimensions from the composition of the present invention using commercially available forming equipment.

The composition may be stored using any means typically employed for patties such as frozen and refrigerated storage and combinations thereof. Suitable methods of cooking the patties for consumption include frying, baking and grilling, and combinations thereof. The patty can be serve with or without a bun and with or without suitable sauces to further enhance the flavor and eating experience.

The products of the invention, i.e. patties, have improved flavor and texture over traditional patties. The crunchy texture provides a pleasing mouthfeel and enhances the delivery of the seasoning ingredients. This characteristic will make the products very desirable for consumers of traditional patty products.

### EXAMPLES

Aspects of select methods in accordance with aspects of the invention are illustrated in the following examples:

### Example 1

TABLE 1
Provides representative examples of formulas for the
composition of the present invention.

| | | % of | % of | | | |
|---|---|---|---|---|---|---|
| Example | Protein | Protein | Ramen | Binder | Seasoning | |
| No. | Material | Material | Noodle | Material | Ingredient | Comments |
| 1 | 90 & 50 | 45 | 45 | Liquid Egg | Ramen | Somewhat |
| | Trim | | | | Chicken | bland tasting - |
| | | | | | Packet | Too much |
| | | | | | | chicken taste |
| 2 | 90 & 50 | 45 | 45 | Liquid Egg | Savory | Good flavor but |
| | Trim | | | | Bulgogi | still lacking |
| | | | | | | ideal level. Also |
| | | | | | | not crispy |
| | | | | | | enough |
| 3 | 90 & 50 | 45 | 45 | Liquid Egg | Spicy Asian | Too spicy. Not |
| | Trim | | | | | neutral enough. |
| | | | | | | Not enough |
| | | | | | | crisp & Flavor |
| 4 | 50 Trim | 46 | 35 | Liquid Egg | Mojo | Improved |
| | | | | | Marinade | crispiness and |
| | | | | | | juiciness. Some |
| | | | | | | felt too low on |
| | | | | | | seasoning |
| | | | | | | delivery. |
| 5 | 50 Trim | 46 | 35 | Dried Egg | Cuban | Binder/flavor |
| | | | | Powder | Mojo | from egg was |
| | | | | | | consistent with |
| | | | | | | liquid egg. New |
| | | | | | | seasoning |
| | | | | | | performed well. |
| | | | | | | Preferred to |
| | | | | | | previous |
| | | | | | | seasoning |

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also be combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

We claim:

1. A food composition comprising:
from about 25 percent to 60 percent by weight of the total food composition of a protein material
from about 20 percent to 55 percent by weight of the total food composition of a ramen noodle
from about 4 percent to 20 percent by weight of the total food composition of a binder material.

2. The food composition of claim 1 further comprising one or more of a seasoning ingredient and water.

3. The food composition of claim 1 wherein the protein material comprises one or more of beef, pork, turkey, chicken, duck, goose, fish, or shellfish.

4. The food composition of claim 3 wherein the protein material is beef.

5. The food composition of claim 1 wherein the binder material comprises one or more of egg, soy, starch, salt, oat fiber, wheat glucose, methyl cellulose, modified wheat gluten, oil and bread crumbs.

6. The food composition of claim 5 wherein the binder material comprises egg.

7. The food composition of claim 2 wherein the seasoning ingredient comprises one or more of asafoetida, achiote paste and powder, allspice, annatto seeds, bay leaf, caraway seed, cardamom, cayenne pepper, chia seeds, cinnamon, cloves, coriander, cumin, fennel seed, fenugreek, garlic powder, gochugaru, grains of paradise, loomi, mace, mahlab, mustard, nutmeg, black pepper, white pepper, nutritional yeast, oregano, paprika, rosemary, saffron, sage, salt, smoked paprika, star anise, sumac, turmeric, thyme, cinnamon, basil, chervil, dill, lemon thyme, marjoram, mint, summer savory, shiso, tarragon, baharat, bouquet garni, chili powder, curry powder, dukkah, herbes de provence, ras el hanout, chipotle seasoning, mojo seasoning blend, or za'atar seasoning blend.

8. The food composition of claim 7 wherein the seasoning ingredient comprises mojo seasoning blend.

9. A patty comprising the food composition of claim 1.

10. A food composition comprising about 40 percent by weight ground beef, about 40 percent by weight ramen noodle, 5 percent by weight dried egg powder, 3 percent by weight Cuban Mojo seasoning blend and 12 percent by weight water.

11. A patty comprising the food composition of claim 10.

12. The patty of claim 9, wherein the shape of the patty is a circle, triangle or a rectangular stick.

13. The patty of claim 9, wherein the thickness of the patty is from about 0.0635 cm to 1.27 cm.
